(19) United States
(12) Patent Application Publication
(10) Pub. No.: US 2025/0326917 A1
(43) Pub. Date: Oct. 23, 2025

(54) NANOMATERIALS, COMPOSITES, ITS USES AND ITS PRODUCTION PROCESSES

(71) Applicant: CENTRO NACIONAL DE PESQUISA EM ENERGIA E MATERIAIS, Campinas (BR)

(72) Inventors: Pedro Ivo Cunha Claro, Campinas (BR); Rubia Figueredo Gouveia, Campinas (BR)

(21) Appl. No.: 18/853,642

(22) PCT Filed: Mar. 31, 2023
(86) PCT No.: PCT/BR2023/050108

§ 371 Date: Oct. 2, 2024

(30) Foreign Application Priority Data
Apr. 4, 2022 (BR) 1020220064571

(51) Int. Cl. C08L 1/02; C08L 7/02

(52) U.S. Cl. CPC C08L 1/02; C08L 7/02

(57) ABSTRACT

The present disclosure describes nanocellulose-based nanomaterials and their incorporation process into composites. Specifically, the present disclosure comprises nanocellulose functionalization processes, promoting better dispersion and homogenization of the nanomaterial in composites, as well as improving physicochemical and mechanical properties. The present disclosure lies in the fields of Chemistry and Materials Engineering.

### CROSS REFERENCE

This application is a national stage entry application under 35 U.S.C. 371 of PCT Patent Application No. PCT/BR2023/050108, filed on Mar. 31, 2023, which claims priority to Brazilian Patent Application No. 1020220064571, filed on Apr. 4, 2022, the entire contents of each of which are incorporated herein by reference.

### FIELD

The present disclosure describes nanocellulose-based nanomaterials and their incorporation process into composites. Specifically, the present disclosure includes nanocellulose functionalization processes, promoting better dispersion and homogenization of the nanomaterial in composites. The present disclosure lies in the fields of Chemistry and Materials Engineering.

### BACKGROUND

Fillers, fibers or reinforcements are additives widely used to reinforce cementitious and/or polymeric composites, which are used in different industrial sectors.

In recent years, interest has been growing in replacing commonly used additives often from non-renewable sources, such as carbon black and silica, by green additives. Therefore, the replacement of synthetic fibers with natural fibers has shown to be very promising, since natural fibers have biodegradable characteristics, are non-toxic and generally have low production costs.

Among natural fibers, the fiber of greatest interest is lignocellulosic fiber, which is abundant in nature and, depending on the functionalization process, can present different physical, chemical and/or morphological properties. Furthermore, cellulose nanocrystals (CNC or CNCs) are of great interest for reinforcing composites, as they present improvements in the optical and physical properties of the materials. However, the incorporation of cellulose nanocrystals into most polymers occurs through extrusion processes of the polymeric material and dehydrated cellulose nanoparticles. In this case, the cellulose nanocrystals tend to agglomerate during the drying process, and dispersion will only partially occur again during the extrusion process, but this does not break down the nanocrystal agglomerates efficiently, since micrometric particles of fillers remain, compromising its dispersion in the matrix of interest and its use as a reinforcing agent.

In the search for the state of the art in patent and scientific literature, the following documents on the subject were found:

Document WO202086419A1, entitled “Methods for improving nanocellulose dispersion in elastomeric compounds, and compositions containing dispersed nanocellulose in elastomer compounds” reveals a polymeric composition for tires, containing nanocellulose and a latex elastomer.

Document CA2898513, titled “Methods, products, and systems relating to making, providing, and using nanocrystalline (NC) products comprising nanocrystalline cellulose (NCC), nanocrystalline (NC) polymers and/or nanocrystalline (NC) plastics or other nanocrystals of cellulose composites or structures, in combination with other materials” reveals several descriptions of different uses of nanocellulose, indicating, among others, the possibility of obtaining nanocellulose airgel by a methodology that comprises a freeze-drying step, without suggesting or anticipating the parameters, proportions of ingredients and process steps of the present disclosure. Thus, CA2898513 comprises only a methodology for obtaining an airgel.

Document WO2020160565A1, entitled “Systems and methods for dewatering and drying nanocellulose” reveals a method for drying nanocellulose and modifying its hydrophobicity. The document in question does not anticipate the production of materials such as those of the present disclosure, in any of its passages.

The document Corrêa et al. 2020, titled “Cellulose nanocrystals from curaua fibers and poly [ethylene-co-(vinyl acetate)] nanocomposites: Effect of drying process of CNCs on thermal and mechanical properties” reveals composites of cellulose nanocrystals with EVA, and its production process includes a freeze-drying step.

Thus, from what can be inferred from the researched literature, no documents were found anticipating or suggesting the teachings of the present disclosure, so that the solution proposed here has novelty and inventive activity compared to the state of the art.

Since none of the located prior art documents comprehend or suggest the teachings and advantages of the present disclosure, it is clear that advances are still needed with regard to the development of additives (nanofillers or nanomaterials) based on nanocellulose, as well as their functionalization.

### SUMMARY

Accordingly, the present disclosure solves the problems of the prior art based on the aqueous dispersion and functionalization of cellulose nanoparticles with polymers dispersible and/or soluble in aqueous media, followed by obtaining a nanomaterial (filler solid) that allows the insertion of nanocellulose-polymer nanoparticles into any polymeric matrix using various processing techniques, such as: extrusion, thermal mixers or simple mixing in a polymeric solution.

In a first object, the present disclosure presents a nanomaterial preparation process comprising the steps of:
a) prepare an aqueous suspension with a concentration of 1% (m/v) to 10% (m/v) of nanocellulose dry mass;
b) add to the suspension obtained in step “a”, from 0.5% to 50% by weight, in relation to the nanocellulose mass, of at least one polymer dispersible and/or soluble in an aqueous medium;
c) freezing the mixture obtained in step “b”;
d) drying of the material obtained in step “c”;
e) micronization of the material obtained in step “d”.

In a second object, the present disclosure presents a nanomaterial obtained by a process as defined above, and by comprising from 99.5% to 50% by mass of nanocellulose and from 0.5% to 50% by mass of at least one polymer. dispersible and/or soluble in aqueous media.

In a third object, the present disclosure presents a composite production process comprising at least one step of adding a solid and dry nanomaterial, as defined above, enabling insertion by the most diverse processing techniques into a polymeric, metallic and/or matrix. or ceramics.

In a fourth object, the present disclosure presents composites comprising from 1% to 20% by mass of a nanomaterial as defined above.

In a fifth object, the present disclosure presents the use of nanomaterial, as defined above, as a reinforcing filler in composites. In one embodiment, the composites are used in coatings.

These and other objects of the disclosure will be immediately appreciated by those skilled in the art and will be described in detail below.

### BRIEF DESCRIPTION OF FIGURES

The following figures are presented:

FIG. 1 shows the comparison with commercial cellulose nanocrystal powder (CNCs) and CNCs functionalized with natural rubber latex (LBN) obtained after lyophilization by freeze-drying.

FIG. 2 shows the structures of CNCs functionalized with natural rubber latex (LBN) obtained by oven drying (E) followed by grinding in a knife mill.

FIG. 3 shows scanning electron microscopy (SEM) images showing the compatibilization of natural rubber latex (LBN) on the surface of cellulose nanocrystals (CNCs) promoted by ice, showing the coalescing of particles in the proportion in the CNC/LBN formulation 50/50 (m/m).

FIG. 4 demonstrates the degree of hydrophobization of cellulose nanocrystals (CNC) with freeze-dried or oven-dried natural rubber latex (LBN) (E) measured from the contact angle of a drop of water.

FIG. 5 shows the transparent visual appearance of the starch films after insertion of the LBN-functionalized CNCs.

FIG. 6 shows the hydrophobization effect of gelatinized starch films with the addition of nanofillers of CNC functionalized with LBN obtained by freeze-drying.

FIG. 7 shows the tensile stress curves versus specific deformation of formulated starch films and the effect of CNC functionalization and drying on mechanical reinforcement and plasticization.

FIG. 8 shows the water vapor permeation test of starch formulations with CNC functionalized by freeze-drying and parafilm (control) covering petri dishes containing 10 ml of water in a controllable environment: 60% (+2) relative humidity and temperature of 23° C. (+2).

FIG. 9 shows the water vapor barrier effect of LBN-functionalized CNCs obtained by freeze-drying in gelatinized starch matrix.

FIG. 10 demonstrates the water vapor permeability (WVP) of starch films with glycerol and reinforced with CNC and LBN at different concentrations.

FIG. 11 shows the micrographs obtained by scanning electron microscopy (SEM) of starch films formulated with CNCs/LBN obtained by freeze-drying indicating the dispersion and distribution of nanofillers throughout the starch matrix.

### DETAILED DESCRIPTION

Despite several researches and studies regarding the incorporation of nanocellulose into composites, there are still several problems in incorporating nanocellulose into these compositions. The main problems are related to the dispersion of nanocellulose, resulting in agglomeration and lack of homogeneity in the system, which in turn causes loss of physical and/or chemical properties of the materials. The problem of incorporating nanocellulose becomes even more pronounced when using cellulose nanocrystals (CNC), due to their high tendency to agglomerate, as they have a structure with strong hydrogen bonds due to the presence of hydroxyl groups in the CNC.

The present disclosure solves this and other problems using reinforcement nanomaterials, comprising functionalized nanocellulose and elastomer polymer-based nanoparticles which have a hydrophobic, elastomeric, mechanical reinforcement and water vapor barrier character. Furthermore, these nanomaterials can be presented in the form of a dry and dispersed powder, facilitating dispersion in composites and increasing the homogeneity of the compositions.

In one embodiment, nanocelluloses are functionalized with elastomer polymers (e.g., natural rubber latex), and transformed into a nanomaterial by a drying method, without agglomeration of the nanocellulose. Therefore, when incorporating the nanomaterials of the present disclosure into composites and/or polymeric matrices, the nanocelluloses are distributed homogeneously, improving the physical and/or chemical characteristics of the materials. In one embodiment, the functionalization process of this project uses renewable sources and does not generate waste, being a green alternative for the production of nanocellulose-based nanomaterials.

In one embodiment, the drying process is carried out by lyophilization by freeze-drying which allows the nanostructures to disintegrate through the growth of the ice and keep them disaggregated after drying due to the sublimation of the ice. Furthermore, the kinetics of ice growth provides the compaction of two two-phase systems together, maintaining their mixture after drying without the use of any type of additional chemical reagent.

Thus, in one aspect the present disclosure proposes to obtain completely dry and disaggregated nanocellulose-based particles functionalized with natural rubber latex (LBN) through ice growth without generating any type of residue. Such functionalization aims to control the degree of hydrophobization of these nanoparticles in addition to providing differentiated properties to the polymeric matrix such as mechanical reinforcement, elasticity, hydrophobicity and even water vapor barrier. Furthermore, the filler is made up of two renewable and naturally abundant raw materials, where its hydrophobicity/hydrophilicity ratio can be dosed according to the application and affinity of the polymeric matrix of interest. Finally, the use of any type of chemical reagent other than water is valid for the application of these functionalized nanoparticles in the most diverse areas of human health, such as cosmetics, and food, such as food packaging, as any type of solvent exudation is avoided.

In a first object, the present disclosure presents a nanomaterial preparation process comprising the steps of:
a) prepare an aqueous suspension with a concentration of 1% (m/v) to 10% (m/v) of nanocellulose dry mass;
b) add the suspension obtained in step “a”, from 0.5% to 50% by mass, in relation to the nanocellulose mass, of a polymer dispersible and/or soluble in an aqueous medium;
c) freezing the mixture obtained in step “b”;
d) drying of the material obtained in step “c”;
e) micronization of the material obtained in step “d”.

In one embodiment, if necessary, the material obtained in step “d” can be redispersed with a solvent, to homogenize the mixture, and subsequently dried.

In one embodiment, the micronization step is grinding in a knife mill.

In one embodiment, in step “c” the aqueous suspension is frozen. In one embodiment, in step “d” lyophilization is carried out by freeze-drying, or spray-drying or by the airgel production process. In one embodiment, in step “d” lyophilization is carried out by freeze-drying. In one embodiment the aqueous suspensions are frozen, in step “c”, at −25° C. for 24 h or frozen in liquid nitrogen, and drying of the frozen suspensions are carried out under vacuum for 48 h.

In one embodiment, the aqueous suspension has a concentration of 2% (m/v) to 9% (m/v) dry mass of nanocellulose. In one embodiment, the aqueous suspension has a concentration of 2% (m/v) to 8% (m/v) dry mass of nanocellulose. In one embodiment, the aqueous suspension has a concentration of 3% (m/v) to 7% (m/v) of nanocellulose dry mass. In one embodiment, the aqueous suspension has a concentration of 3% (m/v) to 6% (m/v) of nanocellulose dry mass. In one embodiment, the aqueous suspension has a concentration of 3% (m/v) to 5% (m/v) dry mass of nanocellulose.

In one embodiment, in step “b” it is added the suspension obtained in step “a”, from 10% to 40% by weight, in relation to the nanocellulose mass, of a polymer dispersible and/or soluble in an aqueous medium. In one embodiment, in step “b” it is added the suspension obtained in step “a”, from 10% to 30% by mass, in relation to the nanocellulose mass, of a polymer dispersible and/or soluble in an aqueous medium. In one embodiment, in step “b” it is added the suspension obtained in step “a”, of 15% to 25% by mass, in relation to the mass of nanocellulose, of a polymer dispersible and/or soluble in an aqueous medium.

In a second object, the present disclosure presents a nanomaterial obtained by a process as defined above, and comprising from 99.5% to 50% by mass of nanocellulose and from 0.5% to 50% by mass of at least one dispersible polymer and/or soluble in aqueous media.

In one embodiment, the nanocellulose is selected from the group consisting of nanofibers (CNF), cellulose nanocrystals (CNCs), or combinations thereof, aiming to obtain a highly dispersed powder. In one embodiment, the nanocellulose is cellulose nanocrystals (CNCs).

In one embodiment, the polymers are elastomers, natural rubber latex and combinations thereof. In one embodiment, the polymer is selected from the group consisting of natural rubber latex, polyolefins, polyurethane, polyvinyl chloride, polystyrene, polyethylene, acrylonitrile butadiene styrene or polycarbonate, polypropylene, ethylene vinyl acetates (EVA) and combinations thereof.

In one embodiment, the nanomaterial comprises from 90% to 60% by mass of nanocellulose and from 10% to 40% by mass of at least one polymer dispersible and/or soluble in aqueous media. In one embodiment, the nanomaterial comprises from 90% to 70% by mass of nanocellulose and from 10% to 30% by mass of at least one polymer dispersible and/or soluble in aqueous media. In one embodiment, the nanomaterial comprises from 85% to 75% by mass of nanocellulose and from 15% to 25% by mass of at least one polymer dispersible and/or soluble in aqueous media.

In a third object, the present disclosure presents a composite production process comprising at least one step of adding a solid and dry nanomaterial, as defined above, enabling insertion by the most diverse processing techniques into a polymeric, metallic and/or ceramics matrix.

In one embodiment, the addition of the nanomaterial is carried out by extrusion, thermal processes or solvent evaporation. Examples of thermal processes include mixing/melting.

In a fourth object, the present disclosure presents composites comprising from 1% to 20% by mass of a nanomaterial as defined above.

In one embodiment, the composites have a polymeric matrix. In one embodiment, the polymer matrix is selected from the group consisting of rubber, natural rubber latex, polyvinyl acetate (PVA), and combinations thereof.

In one embodiment, the composites comprise from 1% to 15% by mass of a nanomaterial as defined above. In one embodiment, the composites comprise from 1% to 10% by mass of a nanomaterial as defined above. In one embodiment, the composites comprise from 5% to 15% by mass of a nanomaterial as defined above.

In a fifth object, the present disclosure presents the use of nanomaterial, as defined above, as a reinforcing filler in composites. In one embodiment, the composites are used in coatings.

In the context of this patent application, the following terms are defined:

Nanomaterial: As used herein, nanomaterial refers to a material that has at least one of its dimensions on the nanometer scale, i.e., with size below 100 nm.

Nanocellulose: As used herein, nanocellulose refers to a lignocellulosic and/or cellulosic material that has at least one of its dimensions on the nanometric scale, i.e., with size below 100 nm.

Cellulose nanofibers: As used herein, refers to cellulose nanoparticles, with a diameter on the nanometric scale, i.e., with a size below 100 nm.

Cellulose nanocrystals: As used herein, refers to the isolated crystalline domains of cellulose nanofibers. They are cellulose nanoparticles with diameters and lengths on the nanometer scale, i.e., with a size below 100 nm.

Composites: As used herein, composites are compositions comprising a metallic, ceramic or polymeric matrix and additional components, such as fillers, and/or fibers, to improve their physical and/or chemical properties.

Polymer Dispersible in Aqueous Media: As used herein, aqueous-dispersible polymers are polymers that form stable and homogeneous dispersions in an aqueous medium at room temperature.

Soluble polymer in aqueous medium: As used herein, aqueous-soluble polymers are polymers that exhibit total solubility in water at room temperature.

Therefore, the present disclosure reveals the obtaining of dry and dispersed powders based on nanocellulose functionalized with polymers dispersible and/or soluble in aqueous media (e.g. natural rubber latex), aiming to control the degree of hydrophobization of cellulose nanostructures. Such functionalization is carried out without the use of any type of chemical reagent or solvent. In one embodiment, freeze-drying lyophilization guarantees a fully dispersed and easily disaggregated powder for insertion into a polymeric matrix using different types of polymeric processing. Furthermore, the nanomaterials in this patent application do not require additives or non-recyclable waste, and can be obtained through a green process.

### EXAMPLES

The examples shown here are intended only to exemplify one of the numerous ways of carrying out the disclosure, however without limiting its scope.

### Nanofillers of CNCs and Natural Rubber Latex

Initially, an aqueous suspension of 4% (w/v) of cellulose nanocrystals (CNCs) was prepared. After preparing the suspension, natural rubber latex (LBN) was added in proportions of 20/80 and 50/50 (m/m) LBN/CNCs. This suspension was mixed by magnetic stirrers for 30 minutes to improve the dispersion of the constituents.

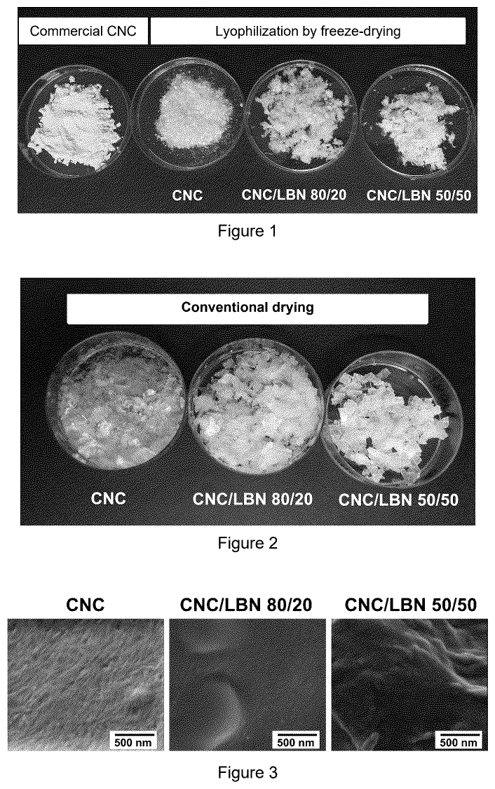

After homogenizing the mixture, it was partitioned into 2 mL plastic containers. Then, the mixtures were frozen at −25° C. for 24 h, with subsequent lyophilization by freeze-drying for 48 hours. At the end of freeze-drying, cylindrical polymeric foams were obtained, which were removed from the containers and micronized by a mechanical knife mill, obtaining a highly dispersed powder compared to commercial cellulose nanocrystal (CNC), as illustrated in FIG. 1.

To demonstrate the effects of different types of drying, the same nanocellulose suspensions were dried, without being frozen, in petri dishes in an oven at 50° C. for 48 h, forming fully compact films. The dried films were ground in a knife mill, forming small sheets, further indicating the adhesion of the nanofillers in relation to each other as illustrated in FIG. 2.

The nanofillers functionalized and dried by freeze-drying were characterized by scanning electron microscopy (SEM), Thermo Fisher Scientific Inspect F50, at 2 KV covered with carbon (FIG. 3).

Natural rubber latex particles (LBN) made compatible on the walls of cellulose nanocrystals (CNCs). The CNC/LBN 50/50 composition demonstrated the coalescence of the latex on the surfaces of the CNCs, homogeneously covering the nanocrystals as shown in FIG. 3.

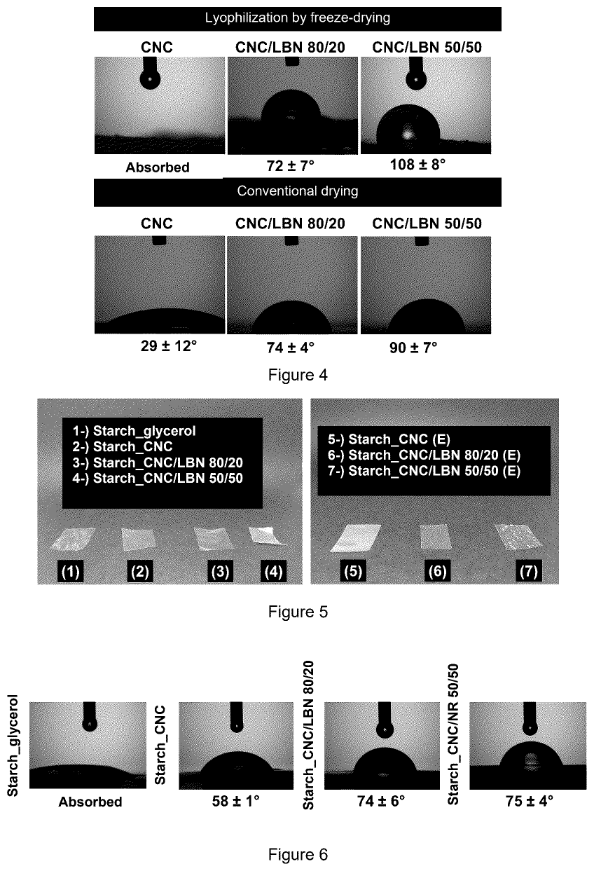

In this way, we obtained nanofillers dried and dispersed with a more hydrophobic character than films dried by conventional drying (as shown in FIG. 4), elastomeric, mechanical reinforcement and moisture barrier for various applications, such as polymeric matrices and/or coating compositions.

### Incorporation of Functionalized Nanofillers

Cellulose nanocrystals (CNCs) functionalized with natural rubber latex (LBN) by freeze-drying or oven drying (E) were incorporated into a hydrophilic and fragile gelatinized starch matrix with the aim of validating their application and consequently improving the properties of this starch matrix. Firstly, 6-8% (w/v) starch was mixed in water at room temperature under mechanical stirring at 700 rpm along with the nanofillers functionalized 10% (m/m) in relation to starch mass. The suspension was heated and maintained at 80° C. for 30 min for complete gelatinization of the starch keeping stirring at 700 rpm. In parallel, samples with freeze-dried or oven-dried CNCs, and starch samples with glycerol (30% w/w in relation to starch mass) were prepared for demonstrate the effect of functionalizing CNCs with LBN in a polymeric matrix. After starch gelatinization, the samples were poured while still hot into petri dishes and dried in an air circulation oven at 60° C. for 48 h. Seven starch film formulations were obtained as shown in FIG. 5: starch_glycerol; starch_CNC; starch_CNC/LBN 80/20; starch_CNC/LBN 50/50; starch_CNC (E); starch_CNC/LBN 80/20 (E) and starch_CNC/LBN 50/50 (E).

In FIG. 6, the contact angle of a drop of water under the surface of the starch films is demonstrated in order to demonstrate the hydrophobization effect of the polymeric matrix with the addition of nanofillers functionalized by freeze-drying. The test was performed on a Theta Lite optical tensiometer (Attention®, USA) in which the angle of the water droplet (10 μl) was measured after 60 s deposited on the surface of the films. The LBN particles incorporated into the CNCs increased the starch's resistance to water, reaching an average contact angle of 75°, a value higher than that demonstrated with just the incorporated CNCs. The starch films with glycerol absorbed water after 60 s, showing little resistance to the water barrier, demonstrating the totally hydrophilic character of gelatinized starch.

Five samples of each starch film formulation (10 mm×50 mm) were tested under tension at a speed of 0.5 mm/min according to ASTM D 882-12 in a universal EMIC testing machine coupled to a 50 kgf load cell at 22° C. (±2) relative humidity of 60% (±5).

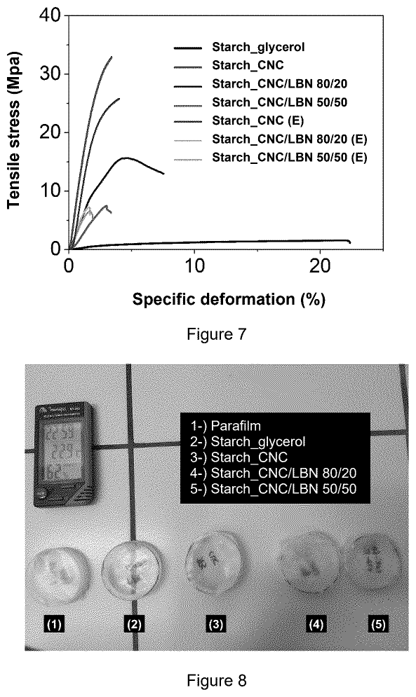

In FIG. 7, representative voltage curves are described versus deformation of the mechanical tensile test of starch films. Starch films with CNC functionalized with LBN showed a gain in mechanical properties with considerable elastic and plastic deformation compared to films with only CNC or glycerol.

In Table 1 are demonstrated the results obtained from the tension curves versus deformation obtained from the tensile test of starch films.

TABLE 1
Stress versus strain curves of starch films

| | Maximum stress | Young's Modulus | Elongation at |
|---|---|---|---|
| Samples | (MPa) | (GPa) | break (%) |
| CNC_glicerol | (1.3 ± 0.1)^{a} | (0.02 ± 0.00)^{a}* | (17.7 ± 1.4)^{a} |
| Starch_CNC | (31.0 ± 1.3)^{b} | (1.5 ± 0.58)^{b} | (3.7 ± 0.2)^{b} |
| Starch_CNC/LBN 80/20 | (15.6 ± 0.7)^{c} | (0.64 ± 0.07)^{c} | (7.4 ± 0.3)^{c} |
| Starch_CNC/LBN 50/50 | (6.8 ± 0.8)^{d} | (0.46 ± 0.08)^{c} | (2.4 ± 0.6)^{b} |
| Starch_CNC (E) | (27.5 ± 0.4)^{e} | (1.6 ± 0.75)^{b} | (3.8 ± 0.4)^{b} |
| Starch_CNC/LBN 80/20 (E) | (7.0 ± 1.2)^{d} | (0.85 ± 0.58)^{c,d} | (1.4 ± 0.2)^{d} |
| Starch_CNC/LBN 50/50 (E) | (5.6 ± 0.8)^{d} | (0.57 ± 0.07)^{d} | (1.6 ± 0.1)^{d} |

Different letters in the same column indicate that the differences in mean values between the formulations are statistically significant (p < 0.05)
*Error is less than 0.01

The starch_CNC/LBN 80/20 formulation was the one that presented the most satisfactory mechanical results, indicating the reinforcing effect of CNCs and the effect plasticizing of LBN, maintaining high values of maximum stress (16 MPa), elongation at break (7%) and Young's modulus (0.6 GPa), compared to other formulations. Starch samples reinforced only with freeze-dried CNC showed highly rigid and brittle characteristics, with elongation at break reaching the lowest value of 2%, pointing only to the reinforcing effect of CNCs. Starch_glycerol samples showed high elongation at break (18%), but they are samples highly sensitive to deformation under tension, presenting a maximum resistance of 1 MPa, indicating the efficient plasticizing effect of glycerol, but without mechanical reinforcement effects.

The starch_CNC/LBN 80/20 (E) sample presented lower maximum tension and elongation at break values compared to the starch_CNC/LBN 80/20 sample, indicating that drying by freeze-drying provided nanofillers functionalized with greater effect under the polymeric matrix. The CNC starch sample (E) also presented a lower maximum stress than the CNC starch sample, showing that drying by freeze-drying also provided nanofillers non-functionalized with greater effect on the polymeric matrix. FIG. 8 shows the water vapor permeation test of gelatinized starch formulations coating petri dishes containing 10 ml of water in a controllable environment: 60% (±2) relative humidity and temperature of 23° C. (±2). Every 24 h the samples were weighed to observe water loss through evaporation. For comparative purposes, parafilm films (control) based on polyolefin and waxes with low water vapor permeability were used as controls.

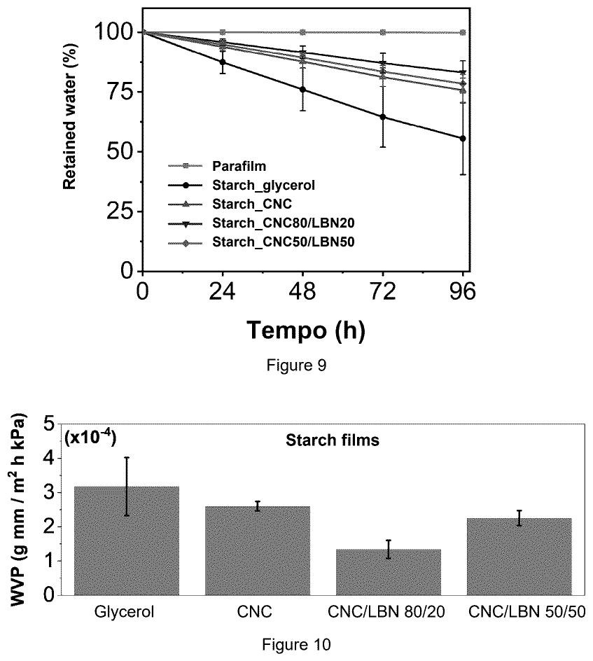

The starch_CNC/LBN 80/20 films showed a water vapor barrier level of around 89% after 96 h, resulting in the closest value to the barrier provided by parafilm films, 99%. On the other hand, the starch_glycerol film presented the lowest water vapor barrier, around 56%, indicating that both CNCs and even more LBN-functionalized CNCs obtained by lyophilization increase the water vapor barrier of the matrix hydrophilic, as illustrated in FIG. 9. These measurements were carried out in triplicates.

Furthermore, FIG. 10 depicts the water permeability of starch films (carried out in triplicates), calculated as a function of water vapor pressure at 23° C. (±2), time, and the thickness and area of the films.

The results demonstrate lower water permeability of starch_CNC/LBN 80/20 films, in contrast to the greater permeability of starch_glycerol films, as demonstrated in FIG. 10.

The cryogenic fracture of starch films was also analyzed to analyze the degree of dispersion and destruction of the nanofillers functionalized obtained by freeze-drying in the polymer matrix. In this case, the films were immersed in liquid nitrogen for cryogenic fracture, covered with platinum (LEICA EM MEDO20) and analyzed in a scanning electron microscope (SEM), Thermo Fisher Scientific Inspect F50 at 2 kV.

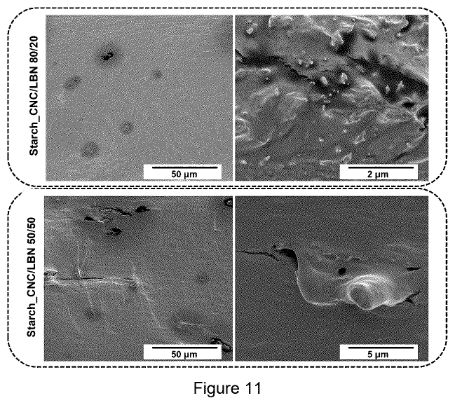

The micrographs presented in FIG. 11 indicate the high degree of compatibility, dispersion and distribution of nanofillers of CNC-LBN throughout the gelatinized starch matrix corroborated by the drying and freeze-drying functionalization process. These characteristics exemplify the effect of mechanical reinforcement, plasticization, hydrophobization and water vapor barrier of CNCs-LBN in the starch matrix based on the physicochemistry of the polymers.

Those skilled in the art will value the knowledge presented here and will be able to reproduce the disclosure in the presented embodiments and in other variants and alternatives, covered by the scope of the following claims.

1. Process for preparing a nanomaterial comprising:
a) prepare an aqueous suspension with a concentration of 1% to 10% (m/v) of nanocellulose;
b) add to the aqueous suspension obtained in step “a”, from 0.5% to 50% by weight, in relation to the nanocellulose mass, at least one of a dispersible polymer and a soluble in an aqueous medium;
c) freezing the mixture obtained in step “b”;
d) drying of the material obtained in step “c”;
e) micronization of the material obtained in step “d”.

2. The process according to claim 1, wherein the micronization step is grinding in a knife mill.

3. The process according to claim 1, wherein the drying step, lyophilization is carried out by freeze-drying, or spray-drying or airgel production.

4. The process according to claim 1, wherein the freezing step is carried out at −25° C. for 24 hours.

5. The process according to claim 1, wherein the freezing step is carried out using liquid nitrogen.

6. A nanomaterial obtained by a process as defined in claim 1, and comprising from 50% to 99.5% by mass of nanocellulose and from 0.5% to 50% by mass of at least one the polymer dispersible and the soluble in aqueous media.

7. The nanomaterial, according to claim 6, wherein the nanocellulose is selected from the group consisting of nanofibers, cellulose nanocrystals and combinations thereof.

8. The nanomaterial, according to claim 6 wherein at least one of the dispersible and the soluble polymer in aqueous medium is selected from the group consisting of rubber, natural rubber latex, polyvinyl acetate (PVA) and combinations thereof.

9. A composite production process comprising: adding a nanomaterial, as defined in claim 6, to at least one of a polymeric matrix, a metallic matrix and a ceramic matrix.

10. The process, according to claim 9, wherein the addition of the nanomaterial is carried out by one of extrusion, thermal processes and solvent evaporation.

11. Composite materials, comprising from 1% to 20% by mass of a nanomaterial as defined in claim 6.

12. A process for using the nanomaterial, as defined in claim 6, comprising: using the nanomaterial as a filler in composites.
